(19) United States
(12) Patent Application Publication
(10) Pub. No.: US 2019/0199722 A1
(43) Pub. Date: Jun. 27, 2019

(54) SYSTEMS AND METHODS FOR NETWORKED COMPUTING

(71) Applicant: Advanta Computer, LLC, Sheridan, WY (US)

(72) Inventor: Kevin Bailey, Dana Point, CA (US)

(21) Appl. No.: 16/225,479

(22) Filed: Dec. 19, 2018

Related U.S. Application Data
(60) Provisional application No. 62/607,628, filed on Dec. 19, 2017.

(51) Int. Cl. H04L 29/06; H04L 9/06

(52) U.S. Cl. CPC H04L 63/0884; H04L 63/0485; H04L 9/0656; H04L 63/0464

(57) ABSTRACT

There is provided a networked computing system comprising one or more network endpoints and an intermediate device which includes a hardware processor connected to a non-transitory memory. The intermediate device is configured to receive a secure input of a type using a one-to-one encryption and decryption protocol from a client computer and communicates with the at least one network endpoint.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### CROSS REFERENCE TO RELATED APPLICATIONS

This patent application claims the benefit of U.S. Provisional Application. No. 62/607,628, filed Dec. 19, 2017, entitled CLOUD COMPUTING SYSTEM DESIGNED TO WORK OVER WIDE AREA NETWORKS OR THE INTERNET.

The entire content of 62/607,628 is hereby incorporated by reference.

### BACKGROUND OF THE INVENTION

### 1. Field of the Invention

The present invention relates generally to networked computing systems and cloud computing systems, and more particularly to a secure cloud computing system designed to work over wide area networks using one-to-one encryption/decryption and authentication methods.

### 2. Description of the Related Art

In markets requiring the use of computers and networked systems, users face a common issue of having to replace computers within about three years because the computers start becoming too slow and the time to process information becomes lengthier than what they were designed to. Computers are also vulnerable to packet sniffing, phishing, hacking and attacks from third parties and data can easily be stolen from local personal computers. These issues increase the expense and management of networked computing systems as well as personal computer.

Although present computers are faster at first, it's still only a matter of time, usually a couple of years or so before the computing powers start slowing down and those same computers becoming susceptible to recent external attacks. In addition, networking and identity management technologies that are somewhat functional are overly complex or otherwise unsatisfactory. Accordingly, a system and method are needed to address the shortfalls of present technology and to provide other new and innovative features.

### SUMMARY OF THE INVENTION

The present disclosure is directed to systems and methods for networked computing using a one-to-one type of encryption/decryption and authentication protocol, substantially as shown in and/or described in connection with at least one of the figures, as set forth more completely in the claims

### BRIEF DESCRIPTION OF THE DRAWINGS

FIG. 1 shows a diagram of an exemplary system for networked computing, according to one implementation of the present disclosure;

FIG. 2 shows a diagram of another exemplary system for networked computing, according to one implementation of the present disclosure;

FIG. 3 shows a flowchart illustrating an exemplary method of networked computing, according to one implementation of the present disclosure; and

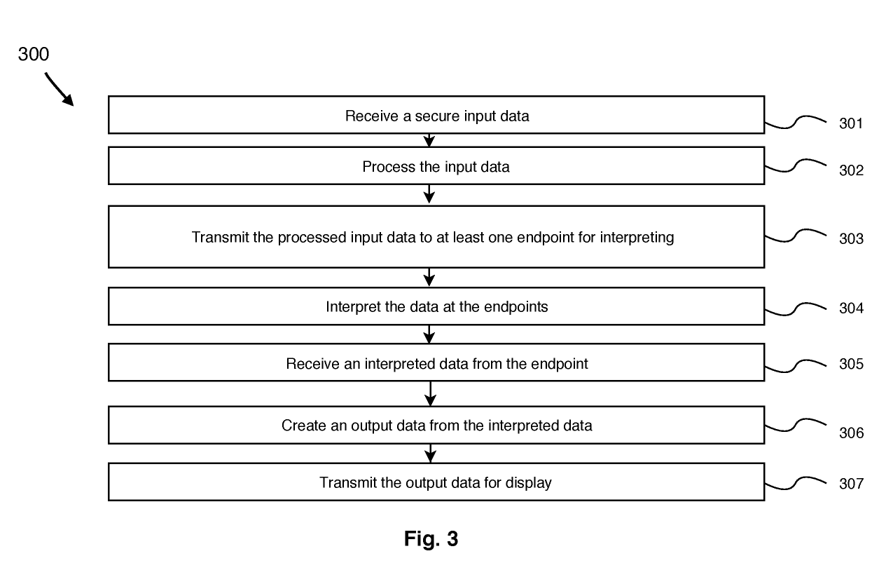

FIG. 4 shows a flowchart illustrating an exemplary method of networked computing, according to one implementation of the present disclosure.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale and are not intended to correspond to actual relative dimensions.

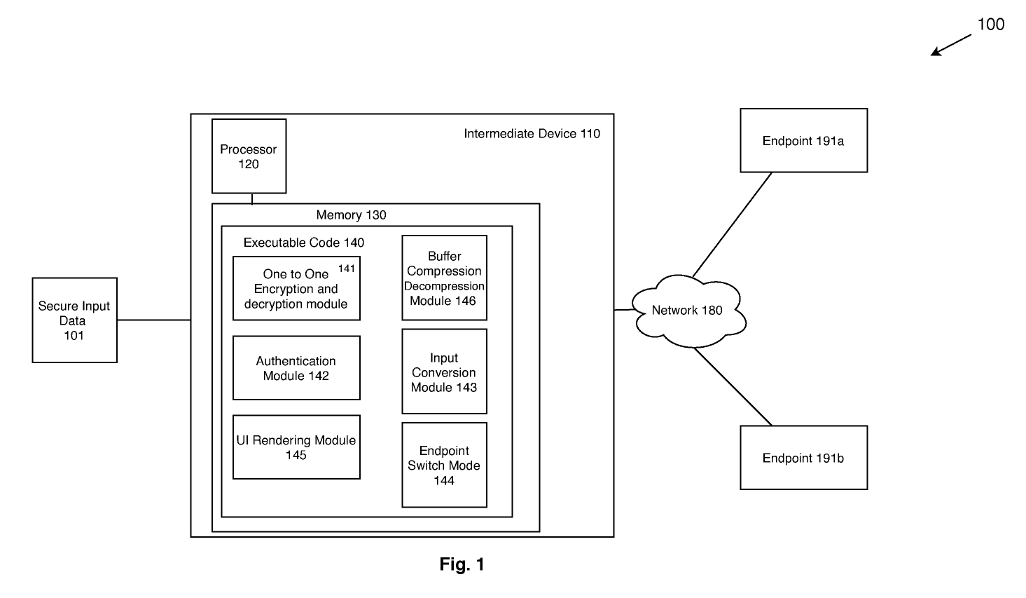

FIG. 1 shows a diagram of an exemplary system for networked computing, according to one implementation of the present disclosure. Prior to discussing the specifics of implementations of the systems and methods of for networked computing, it may be helpful to discuss the network and computing environments in which such implementations may be deployed. Referring now to FIG. 1, an implementation of a networked computing environment is depicted. In brief overview, networked computing system 100 comprises intermediate device 110 in communication with one or more network endpoints 191a, 191b through 191n (also generally referred to as endpoints, or network endpoints including an endpoint non-transitory memory connected to an endpoint hardware processor) and where n in 191n could be any letter or any numbered network endpoints. In some implementations, intermediate device 110 communicates with one of more network endpoints or endpoints 191a, 191b via a network 180.

Networked computing system 100 comprising one or more network endpoint 191a, 191b through 191n; and intermediate device 110. Intermediate device 110 includes processor 120 connected to memory 130. Processor 120 is a hardware processor, such as a central processing unit (CPU), found in computing devices. Memory 130 is a non-transitory storage device for storing computer code for execution by processor 120, and also for storing various data and parameters. Intermediate device 110 may be a computer or server for receiving secure input data 101 using a one-to-one encryption and decryption protocol from a client computer (not shown in FIG. 1) and communicating with one or more network endpoints 191a, 191b, etc. As shown in FIG. 1, memory 130 includes executable code 140. Executable code 140 may contain one or more executable modules for execution by processor 120. As shown in FIG. 1, executable code 140 includes one to one encryption and decryption module 141, authentication module 142, User Interface (UI) rendering module 145, buffer compression and decompression module 146, input conversion module 143, endpoint switch 144, and executable code 140.

In one implementation executable code 140 may contain one or more executable modules for execution by processor 120. As shown in FIG. 1, executable code 140 includes one to one encryption and decryption module 141 adapted to encrypt and decrypt data received by network endpoints and by client computer, authentication module 142 helps authenticate data and client computer information and if the data is authenticated, process information at the intermediate device 110. Authentication module 142 can also be used to authenticate network endpoints and if the network endpoints are authenticated, communicate, process and receive interpreted data by the intermediate device 110 from the one or more network endpoints 191a, 191b etc. User Interface (UI) rendering module 145 helps process input data and output data and renders the information displayable by an output display and helps convert input data for processing. Buffer compression and decompression module 146 helps buffer, compress and decompress data for processing by client computer (not shown in FIG. 1), intermediate device 110 and network endpoints 191a, 191b etc. Input conversion module 143 helps convert input data for processing by intermediate device 110, and endpoint switch 144 helps intermediate device switch communication between one or more network endpoints 191a, 191b etc.

One to one encryption and decryption module 141 is a software module stored in memory 130 for execution by processor 120 to encrypt information or secure input data received from a client computer and decrypt the secure data. Here because intermediate device 110 has most of the computing powers, and connects to one client at the time, a one to one encryption and decryption protocol can be used. And because the client computer only receives input and displays output from intermediate device 110 which is in communication with network endpoints 191, the client computer does not slow down over time from processing too much data and applications. In one implementation, intermediate device 110 hosts most the computing power, modules and applications to enable the intake of secure data and sending the decrypted and processed data to one or more network endpoints for interpretation. The data that is interpreted by network endpoints is sent back to intermediate device 110 for processing and packaging before sending the data to a client computer for a display. In other implementations, the data is sent without encryption or the need for decryption.

In some implementations, when secure input data 101 is sent to intermediate device 110, one to one encryption and decryption module 141 may decrypt the secure input 101, and the decrypted input data is authenticated by the authentication module 142. When the input and client computer are authenticated, the input conversion module may be used to convert the input and send to one or more network endpoints and to communicate with more than one network endpoint, endpoint switch module 144 may be used.

In one implementation, intermediate device 110 of networked computing system 100 communicates with one or more network endpoint 191a, 191b etc. via network 180. In some implementations, network 180 is an inward facing network such as a local area network, an intranet, or a private network. This allows for a more secure networked computing system. To further secure networked computing system 100, in addition to using an inward facing network at network 180, secure input data 101 may be encrypted and sent to the intermediate device for decryption and for authenticating the client computer sending input data 101 using a one to one encryption and decryption protocol for both the decryption and authentication of the client computer sending the input data. Thanks to having an intermediate device communicating with one client computer a one to one encryption and decryption protocol can now be used to secure and authenticate the networked computing system.

In some implementations, the one-to-one encryption and decryption protocol can be any encryption and decryption protocol such as one-time pad (OTP) cipher which required the use of a one-time pre-shared key the same size as, or longer than, the date being sent; secure sockets layer (SSL); advanced encryption standard (AES) which is a symmetric encryption algorithm; data encryption standard (DES); triple data encryption standard (3DES) which is a block cypher and uses three individual keys with 56 bits each and where the total key length can add up to 168 bits; twofish which may be up to 256 bits in length and as a symmetric technique; and/or a blowfish symmetric cipher splits messages into blocks of 64 bits and encrypts them individually or any other encryption/decryption protocol known in the art.

Although FIG. 1 shows a network 180 between the intermediate device and the endpoints or network endpoints 191a, 191b etc., these endpoints and the intermediate device can be on the same network, or on different and multiple networks. The network or networks can be the same type of network or different types of networks. Network 180 can be a local-area network (LAN), such as a company Intranet, a metropolitan area network (MAN), or a wide area network (WAN), such as the Internet or the World Wide Web. In one implementation, network 180 may be a private network or a public network and some endpoints can be on a private network while other endpoints on a public network, or all endpoints can be on different private networks. In some implementations, intermediate device 110 may be located at a branch office of a corporate enterprise communicating via a WAN connection over network 180 to endpoints 191a, 191b, 191n located at a corporate data center.

Network 180 can be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some implementations, network 180 may comprise a wireless link, such as an infrared channel or satellite band. The topology of network 180 may be a bus, star, or ring network topology. Network 180 and network topology may be of any such network or network topology as known to those ordinarily skilled in the art capable of supporting the operations described herein.

In some implementations, intermediate device 110 authenticates input data 101 before processing it using an OTP cipher. In other implementations, intermediate device 110 decrypts input data 101 before authenticating the client computer sending the input data 101. In other implementations, intermediate device 110 authenticates the client computer sending input data 101 before decrypting input data 101.

In one implementation, a networked computing system 100 includes one or more network endpoints 191 and an intermediate device 110. The intermediate device comprises a hardware processor 120 connected to a non-transitory memory 130. In this embodiment, the intermediate device 110 is configured to receive a secure input 101 from a client computer and communicates with the one or more network endpoint 191 via an inward facing network 180.

In another implementation of networked computing system 100, the secure input data 101 is secured using a one-to-one encryption and decryption protocol, and the client computer communicates with the intermediate device 110 via an outward facing network such as a public network 180, a wide area network, a metropolitan area network, internet, or a worldwide web or an inward facing network 180 such as a local area network, an intranet, or a private network.

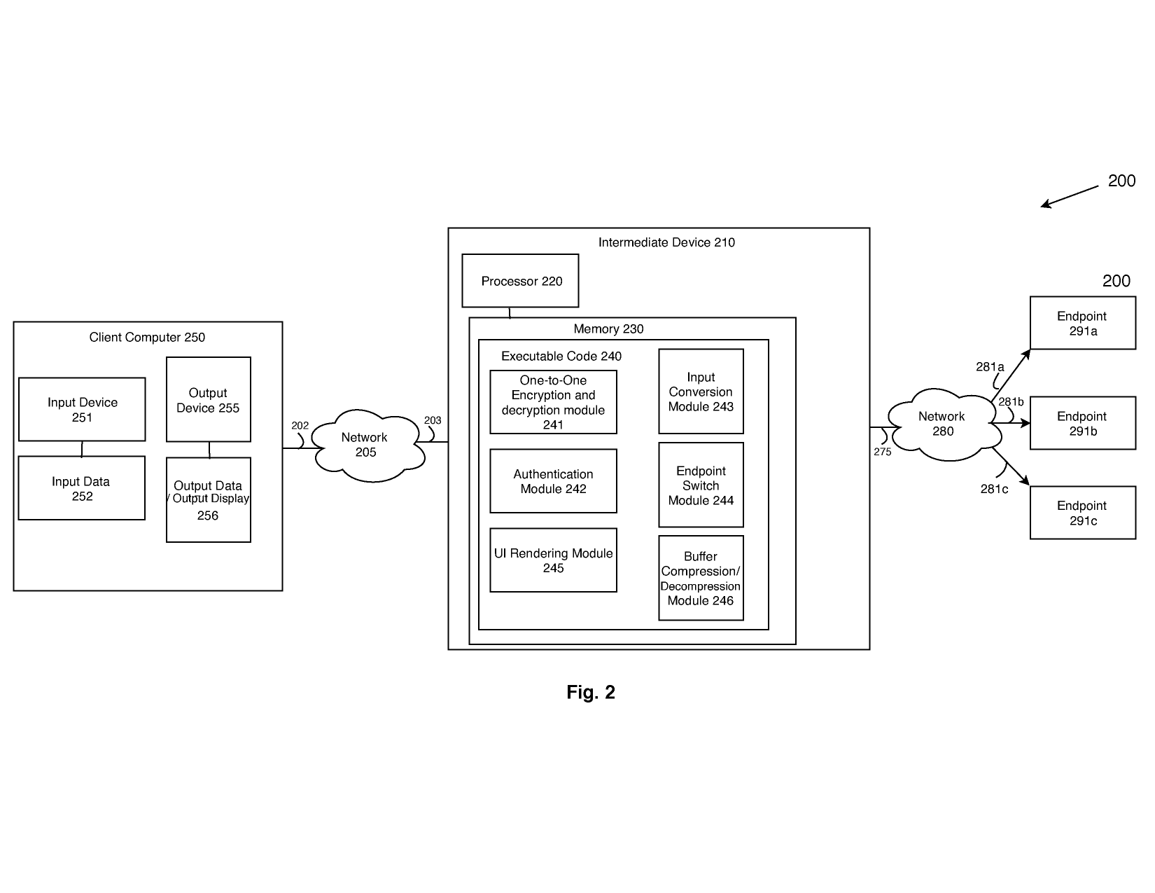

FIG. 2 shows a diagram of another exemplary system for networked computing according to one implementation of the present disclosure. Diagram 200 includes client computer 250, intermediate device 210, and network endpoints 291a, 291b, 291c, and can further include other network endpoints through 291n. As shown in FIG. 2, the client computer 250 includes input device 251 which can receive input data 252, and output device 255 which can display output data 256. Input device 251 may be a physical keyboard, a computer mouse, a touch-screen input device, or other device for receiving input from a user. Output device 255 may be a display screen. In some implementations, client computer 250 does not include these input and output devices 251 and 255 and is simply connected to external input or output devices or can include one or the other (input device 251 and/ or output device 255).

The input device 251 may be a computer, a smart television, a tablet computer, a mobile device, or other device suitable for taking input data. Similarly, the output device 256 may be a computer, a smart television, a tablet computer, a mobile device, or other device suitable for displaying output data.

In one implementation, networked computing system 200 includes client computer 250 which is configured to receive a user input 252; encrypt the user input; send the encrypted and now secure input to intermediate device 210, receive output data 256 from intermediate device 210 and communicate the data for a display output 256 on an output device 255.

In another implementation, the client computer 250 of networked computing system 200 may decrypt an input data which was encrypted using one to one encryption and decryption module 241 of executable 240 of intermediate device 210. While FIG. 1 and FIG. 2 show a one-to-one encryption and decryption module 241 and 141, it is not necessary for the encryption and decryption module to be of a type of one-to-one and any other encryption and decryption module using any encryption and decryption and/or authentication protocols known in the art or a combination thereof can be used to further secure the networked computing systems 100 and 200.

In one implementation, intermediate device 210 of the networked computing system 200 is configured to decrypt encrypted input data 252 from client computer 250, authenticate client computer 250 and if client computer 250 is authenticated, process secure input 252 from client computer 250 and send it to one or more network endpoints 291a, 291b, 291c etc. The intermediate device can then receive an interpreted data the one or more network endpoint 291a, 291b, etc., create an output data from the interpreted data and encrypt output data 256 from the interpreted data; and communicate output data 256 to client computer 250 for a display output on output device 255.

In some implementations, the one or more network endpoints or endpoints 291a, 291b through 291n where n can be any letter or number of networked computing system 200 include an endpoint non-transitory memory (not shown in the figures) connected to an endpoint hardware processor (not shown in the figures). In one implementation, the endpoint hardware processor is configured to receive an input data from intermediate device 210, interprets the input data, assemble an endpoint output from an interpreted input data; and communicates the endpoint output to intermediate device 210.

In another implementation of the networked computing system, a communication between client computer 250 and intermediate device 210 is over network 205. Network 205 can either be an outward facing network, such as a public network, a wide area network, a metropolitan area network, internet, or a worldwide web. In other implementations, network 205 may be an inward facing network, such as a local area network, an intranet, a private network, etc. When an outward facing network is used, the data sent from client computer 250 is preferably encrypted before being sent to intermediate device 210 for added security. In other implementations, intermediate device 210 authenticates client computer 250 before processing and sending data to network endpoints 291a, 291b etc. In other implementations the authentication can be made using any authentication protocols or combination thereof known in the art.

In one implementation, client computer 250 and intermediate device 210 communicate over network 205, and the communication between intermediate device 210 and network endpoints 291a, 291b, etc., is done via a separate network or set of networks 280. In some implementations, intermediate device 210 and/or network endpoints 291a, 291b, etc., may be located on network 280. In other implementations, intermediate device 210 and/or client computer 250 may be connected via network 205.

Although FIG. 2 shows a network 280 between intermediate device 210 and endpoints or network endpoints 291a, 291b, 291c etc., these endpoints and intermediate device 210 can be on the same network, or on different and multiple networks. The network or networks can be the same type of network or different types of networks. Network 280 can be a local-area network (LAN), such as a company Intranet, a metropolitan area network (MAN), or a wide area network (WAN), such as the Internet or the World Wide Web. In one implementation, network 280 may be a private network or a public network and some endpoints can be on a private network while other endpoints on a public network, or all endpoints can be on different private networks. In some implementations, intermediate device 210 may be located at a branch office of a corporate enterprise communicating via a WAN connection over the network 280 to endpoints 191a, 191b, . . . 191n located at a different physical location. In one implementation, intermediate device 210 and network endpoints 291a, 291b, etc., may be connected via an inward facing network or a private network, and input data 252 is encrypted and decrypted by the intermediate device, and the intermediate device authenticates the client computer via a one-time pad cipher for added security. Here the fact that the input data is secure and encrypted, the fact that the client computer is authenticated via an OTP cipher or other one to one type of security protocol and the addition of an inward facing network, such as network 280, between intermediate device 210 and network endpoints 291a, 291b, etc. makes system 200 secure and less susceptible to external attacks and hacking.

The network 280 can be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some implementations, network 180 may comprise a wireless link, such as an infrared channel or satellite band. The topology of network 180 may be a bus, star, or ring network topology. Network 180 and network topology may be of any such network or network topology as known to those ordinarily skilled in the art capable of supporting the operations described herein. 100351 Similarly, FIG. 2 shows a network 205 between the client computer 250 and intermediate device 210. This client computer and intermediate device can be on the same network, or on different and multiple networks. The network or networks can be the same type of network or different types of networks. Network 205 can be a local-area network (LAN), such as a company Intranet, a metropolitan area network (MAN), or a wide area network (WAN), such as the Internet or the World Wide Web. In one implementation, network 205 may be a private network or a public network and the client computer can be on a public network while the intermediate device is on a private network, or both the client computer and intermediate device can be on different public networks. In some implementations, the intermediate device may be located at a branch office of a corporate enterprise communicating via a WAN connection over network 205 to the client computer located at a corporate data center. In a preferred implementation, if network 205 between the intermediate device and the client computer is an outward facing network, the communication 202 and 203 is encrypted.

Network 205 can be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some implementations, network 205 may comprise a wireless link, such as an infrared channel or satellite band. The topology of network 205 may be a bus, star, or ring network topology. Network 205 and network topology may be of any such network or network topology as known to those ordinarily skilled in the art capable of supporting the operations described herein.

In another implementation, the client computer encodes any type and form of data or information into custom or standard TCP and/or IP header fields or option fields of network packet to announce presence, functionality or capability to intermediate device 210. For example, client computer 250 and intermediate device 210 may use TCP option(s) or IP header fields or options to communicate one or more parameters to be used by client computer 250 in performing functionality, or for working in conjunction with intermediate device 210 and network endpoints 291a through 291n.

Method 300 begins at 301, where processor 120 receives secure input data 101 from a client computer by the intermediate device 110. At 302, intermediate device 110 processes input data 101, and at 303, intermediate device 110 transmits the processed input data to at least one endpoint 191 for interpreting. At 304, the network endpoint or endpoints 191a, 191b through 191n interpret the data sent by intermediate device 110 and at 305, the endpoints send an interpreted data to the intermediate device 110. At 306, executable code 140 of intermediate device 110 received an interpreted data from the endpoints, and at 307, intermediate device 110 transmits an output data for display.

In one implementation, method 300 includes having an intermediate device 110 including a non-transitory memory connected to a hardware processor, where at 301, intermediate device 110 or hardware processor 120 of intermediate device 110 receives secure input 101 of a type using a one-to-one encryption and decryption protocol from a client computer and at 303, hardware processor 120 communicates with one or more network endpoint 191n.

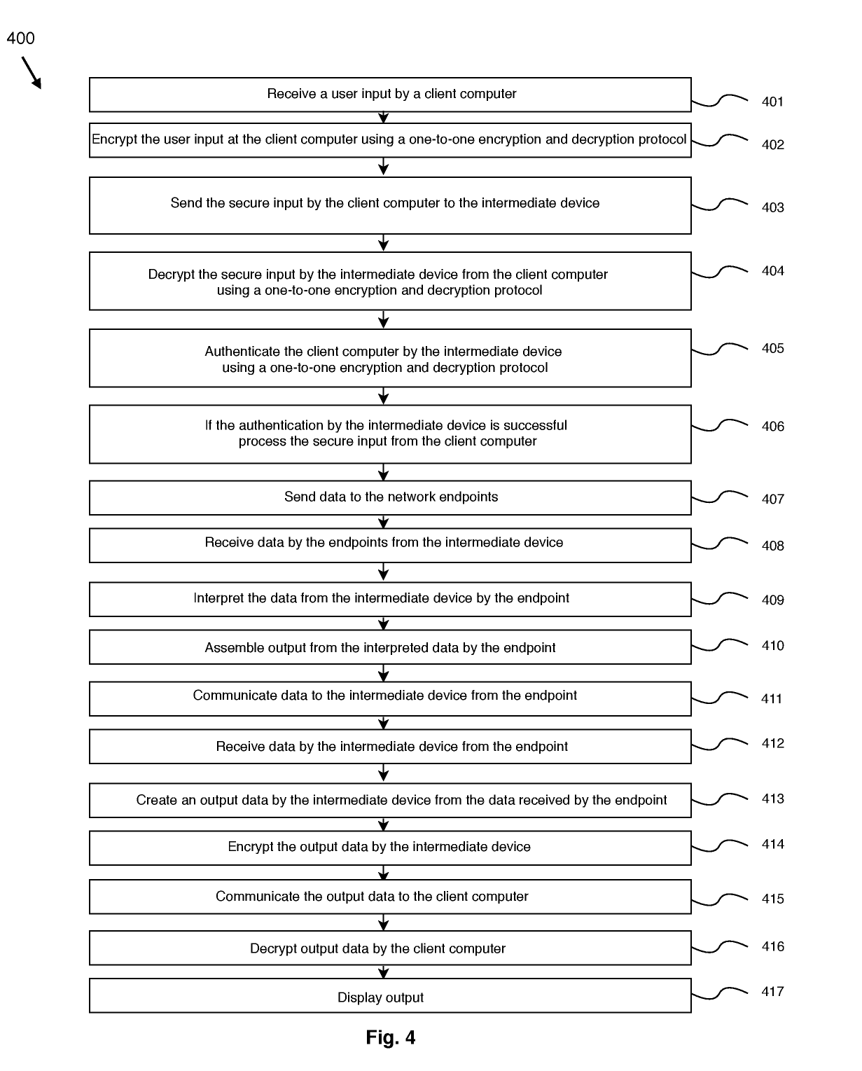

FIG. 4 shows a flowchart illustrating an exemplary method of networked computing, according to one implementation of the present disclosure. Method 400 starts at 401 where hardware processor 220 of intermediate device 210 receives user input 252. At 402, the client computer 250 encrypts user input 252 using a one-to-one encryption and decryption protocol, and at 403, the client computer 250 sends a secure and encrypted input intermediate device 210. At 404, the executable code 240 decrypts the secure input 252 using a one-to-one encryption and decryption protocol. In other implementations any encryption/decryption protocol known in the art can be used.

At 405, intermediate device 210 authenticate client computer 210 using a one-to-one encryption and decryption protocol. In other implementations any encryption/decryption protocol or authentication protocol known in the art can be used. At 405, intermediate device 210 authenticate client computer 210 using an OTP cipher.

At 406, if intermediate device 210 properly authenticates client computer 250 and if the authentication is successful, intermediate device 210 processes the secure input 252.

At 407, intermediate device 210 sends data to one or more network endpoints 291a, 291b, etc. At 408, network endpoints 291a, 291b etc receive data from intermediate device 210. In one implementation, the network endpoints include a processor connected to a memory and these network endpoints interpret the data from intermediate device 210 at 409. At 410, the network endpoints assemble an output from the interpreted data and at 411, the one or more network endpoints communicate data to intermediate device 210.

At 412, intermediate device 250 receives data from the network endpoints and create an output data from the data received by the endpoint at 413. In one implementation, intermediate device 210 encrypts the output data at 414, while in other implementation, the output data can be directly communicated to the client computer by intermediate device 210 at 415 while skipping the encryption and step 414.

If the output data is encrypted by intermediate device 210 at 414, then client computer 250 decrypts the output data at 416. If the output data was not encrypted by intermediate device 210 and step 414 is skipped, then the data is communicated by the intermediate device to client computer 250 for a display output at 417.

In one implementation of the present disclosure, intermediate device 110 includes a non-transitory memory connected to a hardware processor and a method for networked computing includes the steps of: receiving, by the hardware processor 120, a secure input 101 of a type using a one-to-one encryption and decryption protocol from a client computer and communicating, by the hardware processor 110, with at least one network endpoint 191a.

In another implementation, a networked processing system 200 includes client computer 250, a plurality of network endpoints (291a, 291b, 291c through 291n etc.), and intermediate device 210 which includes non-transitory memory 230 storing authentication identification module 242 and executable code 240, a hardware processor 220 executing the executable code 240 to receive an encrypted client identification from the client computer, where the encrypted client identification is encrypted by a one-time pad (OTP) encryption; decrypt the encrypted client identification, compare the client identification with the authentication identification to verify an identity of the client computer, receive an input data 251 from client computer 250, where input data 251 is encrypted using a secure encryption protocol, decrypt the input data, process the input data, transmit the input data to a first endpoint 291 a for interpreting; receive an interpreted data from the first endpoint; create an output data by encrypting the interpreted data and transmit output data 256 to client computer 250.

In one implementation executable code 240 may contain one or more executable modules for execution by processor 220. As shown in FIG. 2, executable code 240 includes one to one encryption and decryption module 241 adapted to encrypt and decrypt data received by network endpoints and by client computer, authentication module 242 helps authenticate data and client computer information and if the data is authenticated, process information at the intermediate device 210. Authentication module 242 can also be used to authenticate network endpoints and if the network endpoints are authenticated, communicate, process and receive interpreted data by the intermediate device 210 from the one or more network endpoints 291a, 291b etc. User Interface (UI) rendering module 245 helps process input data and output data and renders the information displayable by an output display and helps convert input data for processing. Buffer compression and decompression module 246 helps buffer, compress and decompress data for processing by client computer 250, intermediate device 210 and network endpoints 291a, 291b etc. Input conversion module 243 helps convert input data for processing by intermediate device 210, and endpoint switch 244 helps intermediate device switch communication between one or more network endpoints 291a, 291b etc.

In another implementation, the method communication between intermediate device 210 and network endpoints (291a, 291b etc.) at 407, 408, 411 and 412 is via an inward facing network such as a local area network, an intranet, or a private network.

In another implementation, method 400 includes client computer 250 and includes the steps of receiving a user input by client computer 250 at 401, encrypting user input 251 by client computer 250 at 402, sending the secure input by client computer 250 to intermediate device 210, receiving an output by client computer 250 from intermediate device 210, and communicating by intermediate device 210 a display output 256.

In another implementation of method 400 discussed above, client computer 250 decrypts an encrypted output from intermediate device 210. In another implementation, method 400 also includes the steps of decrypting secure input 251 from client computer 250 by intermediate device 210, authenticating client computer 250 by intermediate device 210 and if client computer 250 is authenticated, processing the secure input from client computer 250 and sending the input to one or more network endpoint 291a, etc, receiving an interpreted data by intermediate device 210 from one or more network endpoints 291a, 291b etc, creating and encrypting an output data by the intermediate device from the interpreted data; and communicating the output data by intermediate device 210 to client computer 250 for a display output. In one implementation, the authenticating of client computer 250 is done via a one-time pad cipher whereas in other implementations, the authentication can be done using any encryption/decryption protocol or authentication protocol known in the art.

In yet another implementation, network endpoints 291a, 291b, and 291c or more network endpoints include an endpoint non-transitory memory connected to an endpoint hardware processor. These network endpoints can receive an input data from the intermediate device by the endpoint hardware processor; interpreting the input data by the endpoint hardware processor; assemble an endpoint output from an interpreted input data by the endpoint hardware processor; and communicate the endpoint output to the intermediate device by the endpoint hardware processor.

In another implementation, the communication between client computer 250 and intermediate device 210 is over an outward facing network 205 such as a public network, a wide area network, a metropolitan area network, the Internet, or a worldwide web, whereas in another implementation the communication between client computer 250 and intermediate device 210 is over an inward facing network such as a local area network, an intranet, or a private network.

In one implementation, the networked computing system includes client computer 250, which in turn can include input device 251 and/or output device 255. In other implementations, client computer 250 does not include any input or output devices but is connected to an input device for receiving input from a user and an output device to be able to display the output. The system can also include intermediate device 210 which includes hardware processor 220 connected to memory 230 and one or more network endpoints (291a, 291b etc.) Intermediate device 210 is intermediary between a client computer and network endpoints 291a, 291b, etc., and has two different facing network communications: one network communication facing the client computer 250 and one network communication facing the network endpoints 291a, 291b etc. These networks can be public or private.

In one implementation, client device 250 can receive user input 252, package and encrypt user input 252, send packaged and encrypted user input 252 to intermediate device 210; receive a packaged and encrypted output from intermediate device 210, decrypt the packaged and encrypted output from intermediate device 210 and communicate a decrypted display output 256

In another implementation, intermediate device 210 can receive packaged and encrypted user input from client computer 250, decrypt and process the packaged and encrypted user input, communicate a decrypted and processed input data to the network endpoint for interpreting, receive an interpreted data from the network endpoint(s), create an output data by encrypting and packaging the interpreted data, and communicate the packaged and encrypted output to the client computer for display output.

In another implementation, the network endpoint or network endpoints 291a, 291b, etc., can receive the decrypted and processed input data from the intermediate device 210, interpret the decrypted and processed input data, assemble an endpoint output from the interpreted data, and communicate the interpreted data to intermediate device 210.

In one implementation, intermediate device 210 is configured to receive, via a user interface provided by client computer 250, an authentication credential of a user to authenticate the user to intermediate device 210. In another implementation, once a user is authenticated, the data can then be sent to one or more network endpoints.

From the above description, it is manifest that various techniques can be used for implementing the concepts described in the present application without departing from the scope of those concepts. Moreover, while the concepts have been described with specific reference to certain implementations, a person having ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A networked computing system comprising:
at least one network endpoint; and
an intermediate device including a hardware processor connected to a non-transitory memory, wherein the intermediate device is configured to receive a secure input of a type using a one-to-one encryption and decryption protocol from a client computer and communicates with the at least one network endpoint.

2. The networked computing system of claim 1, wherein the one-to-one encryption and decryption protocol is one of a one-time pad (OTP) cipher, a secure sockets layer (SSL), an advanced encryption standard (AES), a data encryption standard (DES), a triple data encryption standard (3DES), a twofish, and a blowfish.

3. The networked computing system of claim 1, wherein the intermediate device communicates with the at least one network endpoint via an inward facing network such as a local area network, an intranet, or a private network.

4. The networked computing system of claim 1, wherein the intermediate device is further configured to authenticate the client computer via a one-time pad cipher.

5. The networked computing system of claim 1 further comprising a client computer configured to: a) receive a user input; b) encrypt said user input; c) send the secure input to the intermediate device; d) receive an output from the intermediate device; and e) communicate a display output.

6. The networked computing system of claim 5, wherein the client computer is further configured to decrypt an encrypted output from the intermediate device.

7. The networked computing system of claim 1, wherein the intermediate device is further configured to: a) decrypt the secure input from the client computer; b) authenticate the client computer and if the client computer is authenticated, process the secure input from the client and send it to the at least one network endpoint; c) receive an interpreted data from the at least one network endpoint; d) create an output data from the interpreted data; e) encrypt the output data from the interpreted data; and f) communicate the output data to the client computer for a display output.

8. The networked computing system of claim 1, wherein the at least one network endpoint comprises an endpoint non-transitory memory connected to an endpoint hardware processor, the endpoint hardware processor configured to: a) receive an input data from the intermediate device; b) interpret the input data; c) assemble an endpoint output from an interpreted input data; and e) communicate the endpoint output to the intermediate device.

9. The networked computing system of claim 1, wherein a communication between the client computer and the intermediate device is over an outward facing network such as a public network, a wide area network, a metropolitan area network, internet, or a worldwide web or an inward facing network such as a local area network, an intranet, or a private network.

10. A method for execution by an intermediate device, the intermediate device including a non-transitory memory connected to a hardware processor, the method comprising:
a) receiving, by the hardware processor, a secure input of a type using a one-to-one encryption and decryption protocol from a client computer;
b) communicating, by the hardware processor, with at least one network endpoint.

11. The method of claim 10, wherein the one-to-one encryption and decryption protocol is one of a one-time pad (OTP) cipher, a secure sockets layer (SSL), an advanced encryption standard (AES), a data encryption standard (DES), a triple data encryption standard (3DES), a twofish, and a blowfish.

12. The method of claim 10, wherein the communicating, by the hardware processor, with the at least one network endpoint is via an inward facing network such as a local area network, an intranet, or a private network.

13. The method of claim 10 including a client computer and further comprising the steps of:
a) receiving a user input by the client computer;
b) encrypting the user input by the client computer;
c) sending the secure input by the client computer to the intermediate device;
d) receiving an output by the client computer from the intermediate device; and
e) communicating a display output.

14. The method of claim 13 further comprising decrypting an encrypted output from the intermediate device by the client computer.

15. The method of claim 10 further comprising the steps of:
a) decrypting the secure input from the client computer by the intermediate device;
b) authenticating the client computer by the intermediate device and if the client computer is authenticated, processing the secure input from the client and sending it to the at least one network endpoint;
c) receiving an interpreted data by the intermediate device from the at least one network endpoint;
d) creating and encrypting an output data by the intermediate device from the interpreted data; and
e) communicating the output data by the intermediate device to the client computer for a display output.

16. The method of claim 15, wherein the authenticating of the client computer by the intermediate device is via a one-time pad cipher.

17. The method of claim 10, wherein the at least one network endpoint includes an endpoint non-transitory memory connected to an endpoint hardware processor, and further comprising the steps of:
a) receiving an input data from the intermediate device by the endpoint hardware processor;
b) interpreting the input data by the endpoint hardware processor;
c) assembling an endpoint output from an interpreted input data by the endpoint hardware processor; and
e) communicating the endpoint output to the intermediate device by the endpoint hardware processor.

18. The method of claim 10, wherein a communication between the client computer and the intermediate device is over an outward facing network such as a public network, a wide area network, a metropolitan area network, internet, or a worldwide web or an inward facing network such as a local area network, an intranet, or a private network.

19. A networked computing system comprising:
at least one network endpoint; and
an intermediate device including a hardware processor connected to a non-transitory memory, wherein the intermediate device is configured to receive a secure input from a client computer and communicates with the at least one network endpoint via an inward facing network.

20. The networked computing system of claim 1, wherein the secure input is of a type using a one-to-one encryption and decryption protocol and the client computer communicates with the intermediate device via an outward facing network or an inward facing network.
